(19) United States
(12) Patent Application Publication
(10) Pub. No.: US 2014/0001914 A1
(43) Pub. Date: Jan. 2, 2014

(54) STATOR FOR AN ELECTRIC MOTOR AND METHOD FOR PRODUCING A STATOR FOR AN ELECTRIC MOTOR

(71) Applicants: Michael Schmohl, Ammerbuch (DE); Felix Ebner, Goppingen (DE); Enrico Flote, Frickenhausen-Linsenhofen (DE)

(72) Inventors: Michael Schmohl, Ammerbuch (DE); Felix Ebner, Goppingen (DE); Enrico Flote, Frickenhausen-Linsenhofen (DE)

(21) Appl. No.: 13/712,021

(22) Filed: Dec. 12, 2012

(30) Foreign Application Priority Data
Dec. 14, 2011 (DE) 10 2011 088 519.6

(51) Int. Cl. H02K 15/02; H02K 3/12

(52) U.S. Cl. CPC H02K 15/024; H02K 3/12
USPC 310/216.074; 29/596

(57) ABSTRACT

A novel stator for an electric drive, is described and which includes—a stator body defining a coil space for accommodating a coil wire in the form of a coil, and wherein the coil space comprises a plurality of slots, which are delimited by a stator wall and pole horns made integral with the stator; and wherein—the coil wire is inserted into the coil space, and is subsequently wound out via the slot in the region which is located between the two pole horns. In addition, the disclosed invention relates to a method for producing a stator.

### RELATED PATENT DATA

The present patent application claims priority from German patent application Serial No. 10 2011 088 519.6, and which was filed on Dec. 14, 2011.

The present invention relates to a stator for an electric motor and to a method for producing a stator for an electric motor.

Such stators are used in electric drives or electric motors and which also comprise a rotor, in addition to the stator. A conventional application of such electric drives is in household appliances and electric machine tools.

A stator of an electric drive or an electric motor with a corresponding rotor generally has a stator body with a closed stator wall, and pole horns or pole tips arranged thereon. The rotor of the electric drive is arranged within these pole horns and moves in a rotary fashion about an axis of rotation within and relative to said stator. The stator body, which is generally produced from iron-containing material (iron), has a coil space which comprises a number of coil slots, and which are delimited by the respective pole horns and the stator wall of the stator. Generally, an insulated coil wire or field coils manufactured from such a wire are inserted into these coil slots.

Electric drives with a stator, and a rotor arranged therein, are generally air-cooled, and wherein ambient air is sucked into and then sucked through the electric drive. The air flowing through the electric drive dissipates the heat from the coil wire and in the process ensures that the electric drive can output sufficient power without overheating.

One disadvantage which has become apparent in practice in connection with the air-cooling of electric drives consists in that dust particles are often contained in the cooling air. These dust particles can attack the coil wire and thus result in an abrasion of the coil wire.

In order to counteract this problem, it is known from practice to provide wind banding and/or insulating paper around the manually inserted, prewound coils prior to the insertion of the coils into the coil space. In this case, however, this additional working step of wrapping the prewound coils is extremely complex, and therefore both time-consuming and cost-intensive in terms of production. Further disadvantages of manually inserted, prewound coils result from the likewise cost-intensive and time-consuming step of manually inserting the coil into the coil space, and from the circumstance by which the coil space can never be utilized completely in the case of manually inserted coils since there is always a small gap remaining between the coil slot and the inserted prewound coil.

Alternatively, the coil space of a stator body may be wound directly with coil wire, and preferably with the aid of a needle winding machine or the like, since, as a result, an increased packing density of the coil wire in the coil space is achieved. Furthermore, quick winding can take place. In this case, the coil wire is inserted with a space factor of less than about 100% of the coil slots.

However, one disadvantage in this arrangement is that not all of the physical space which is available can be utilized for forming the coils.

One object of the present invention, therefore, consists in providing a compact, robust, high-performance electric motor.

This object of the present invention is achieved by providing a stator for an electric drive which has the features of Claim 1, and by a method having the features of Claim 6. The dependent claims relate to advantageous embodiments and developments of the present invention.

The stator according to the present invention comprises a stator body defining a coil space for accommodating a coil wire in the form of a coil, and wherein the coil space comprises a plurality of slots, which are delimited by a stator wall, and pole horns of the stator. According to the teachings of the present invention, the coil wire is wound out via a slot which is provided in the region between two pole horns.

By virtue of the fact that a cohesive connection between the turns of the coil is established, at least partially, and at least in parts of that region of the coil which is located outside the slot, it is possible to achieve a construction in which the coil remains mechanically stable even without the supportive effect provided by the pole horns.

One advantageous variant of the aforementioned cohesive connection can be achieved by virtue of the fact that the coil wire is at least partially in the form of a baked-enamel wire. A baked-enamel wire is understood to mean a coil wire which has a thermally resistant base insulation and a cover layer which agglutinates on heating and often also polymerizes in the process.

As a result of the fact that about 40-60% of the coil wire is arranged outside the slot, the physical space which is made available can be utilized in a particularly advantageous manner.

As a result of the fact that the cohesive connection is formed at least partially by an impregnating resin, a particularly permanent mechanical stabilization of the coil can also be achieved.

An advantageous method for producing a stator as described above comprises the following steps:
inserting a former into a stator segment;
introducing the coil wire into the coil space, and wherein the coil wire is wound out via the slot in the region between two pole horns;
cohesively connecting the turns of the coil at least partially, at least in parts, of that region of the coil which is located outside the slot; and
removing the former.

If, for example, the cohesive connection is performed using a baked-enamel wire as coil wire, this can be achieved, for example, by virtue of the fact that the baked-enamel wire is subjected to an electrical current and is heated thereby.

For provisional stabilization of the coil for the subsequent handling steps in the context of the production process, it is sufficient if an electrical current with a current intensity in the range of about 30-70 A, and in particular, about 50 A, is used for a time period of less than 10 seconds, for example, 3-5 seconds, and in particular, about 4 seconds. As a result, the clock times can be kept short during the manufacture of same. For example, the turns can be brought to a temperature of approximately 200 degrees C. for about 5 seconds.

In particular for the final cohesive connection of the turns, in addition or as an alternative to that which was previously described, an impregnating resin can be used. In this form of the invention, the stator body can be immersed in the impregnating resin. The immersion provides another way of providing the coil with the impregnating resin, and which can shorten the manufacturing time. Thus, for example, a large number of stator bodies can be immersed in an impregnating resin bath simultaneously, with the result that the quotient of the curing time of the impregnating resin and the number of simultaneously treated stator heads determines the manufacturing time for this step per each manufactured stator head. This provides the advantage over the prior art that the virtually unparallizable step of energizing the baked-enamel wire can be kept short in terms of time. For example, after the provisional fixing by virtue of heating the turns, as described, above, the stator bodies can be immersed in an impregnating resin bath at a temperature range of about 100 degrees C. to about 140 degrees C., and in particular about 120 degrees C.

The invention will be explained in more detail below with reference to the accompanying drawings.

The attached figures show, by way of example, a preferred embodiment of the invention. However, a person skilled in the art will, of course, will also consider these features separately from one another and/or will be able to combine them to form other expedient combinations.

In the drawings:

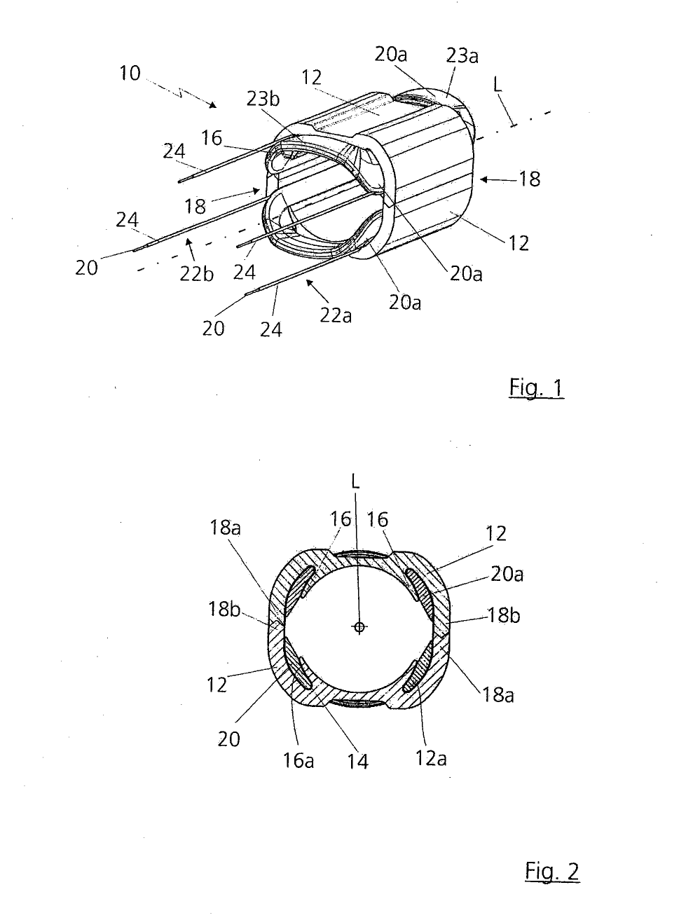

FIG. 1 illustrates an isometric view of a two-pole stator;

FIG. 2 illustrates a transverse, vertical sectional view of the stator shown in FIG. 1;

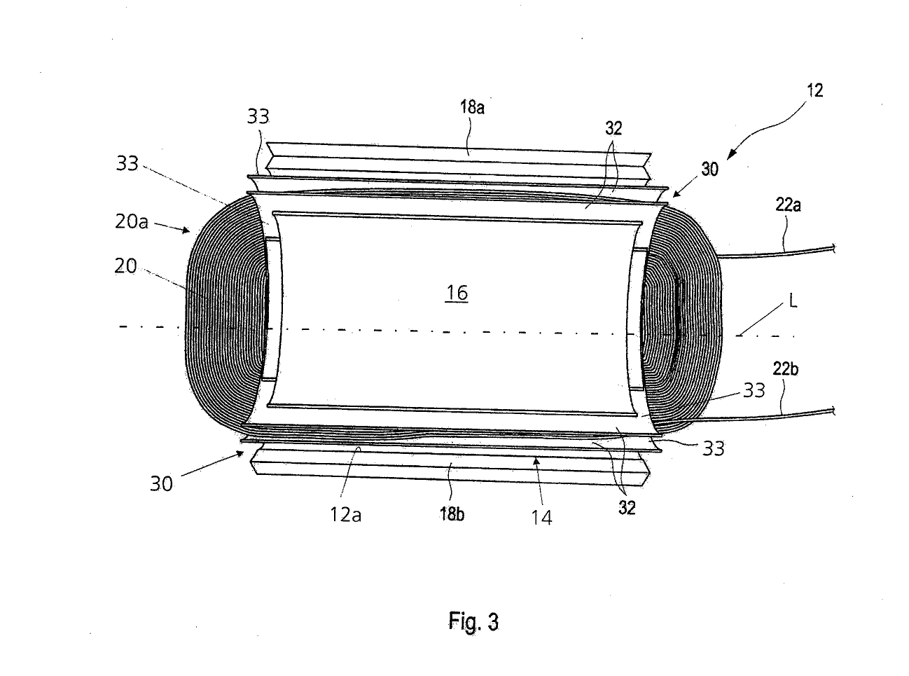

FIG. 3 shows a plan view of a stator half of the stator shown in FIGS. 1 and 2;

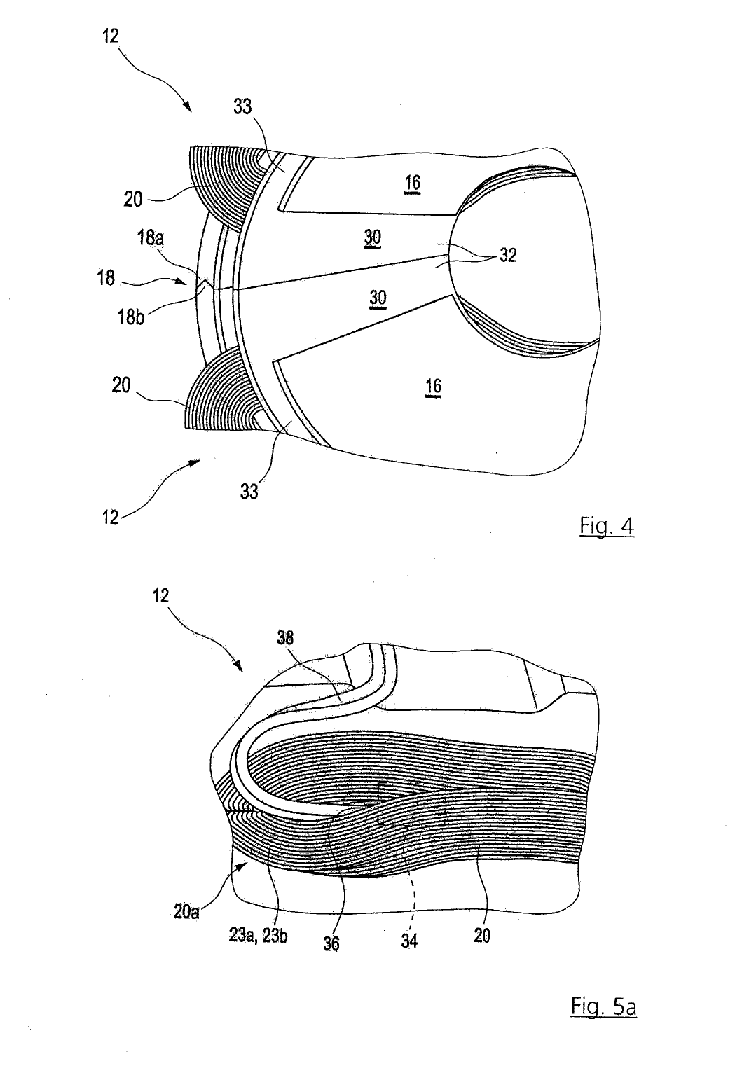

FIG. 4 shows a partial and greatly enlarged, side elevation view of a connection point of the stator as shown in FIGS. 1 and 2;

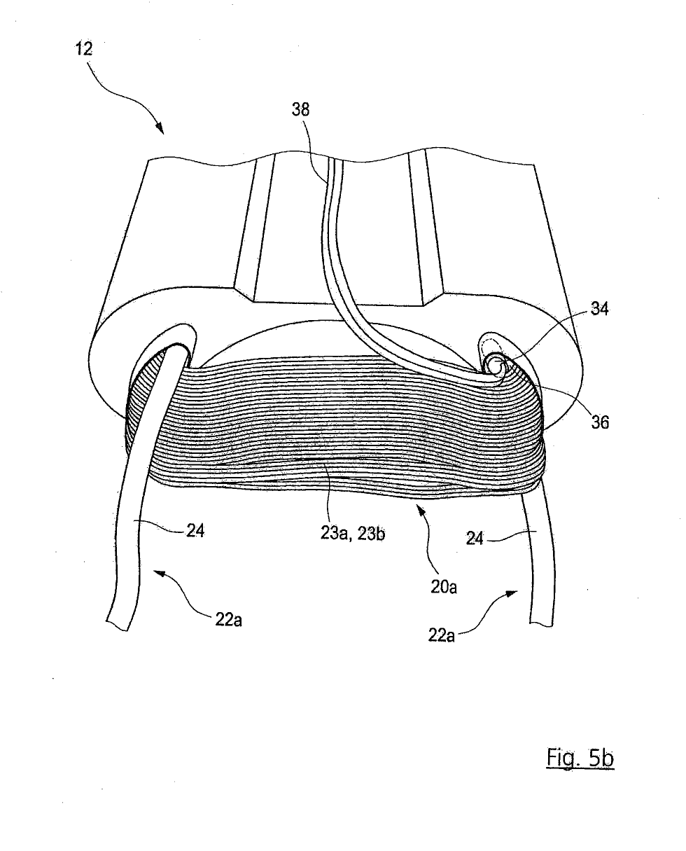

FIG. 5a shows a partial, greatly enlarged, side elevation view of a stator half with a temperature sensor element in a first possible embodiment of the invention;

FIG. 5b shows a partial, greatly enlarged, side elevation view of a stator half with a temperature sensor element in a second possible embodiment of the invention;

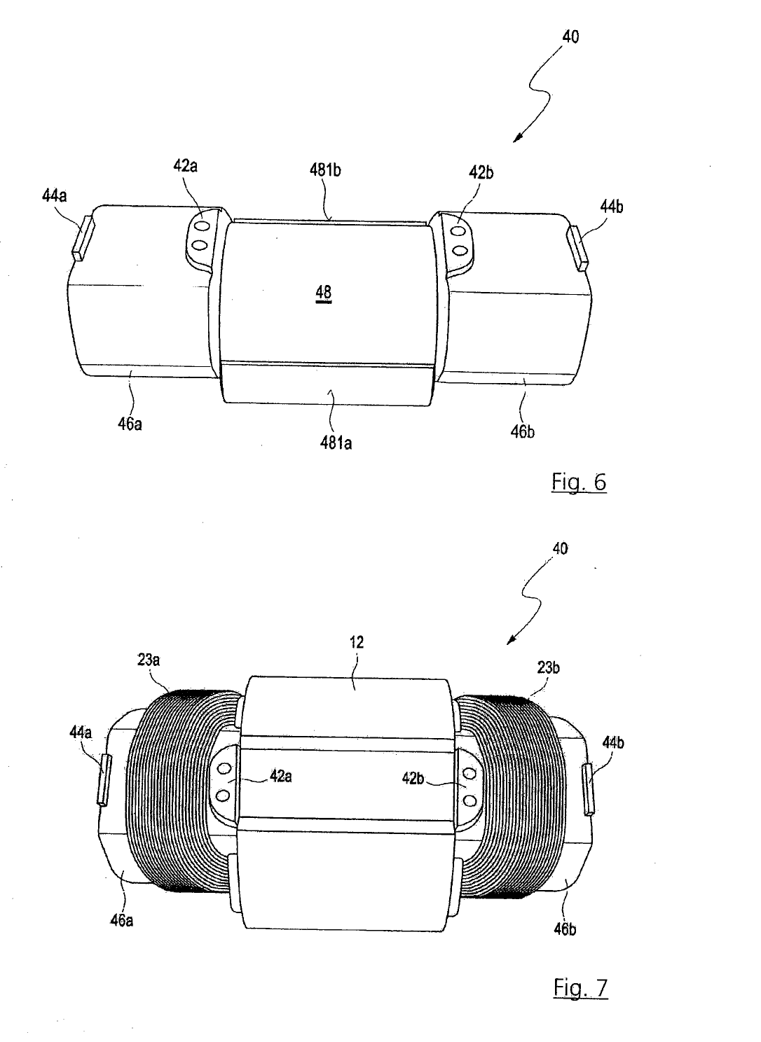

FIG. 6 shows a partial and greatly enlarged, side elevation view of a former which can be used in a winding operation for forming a stator according to the teachings of the present invention;

FIG. 7 shows in a perspective, side elevation view of a former inserted into a stator half after the completion of a winding operation;

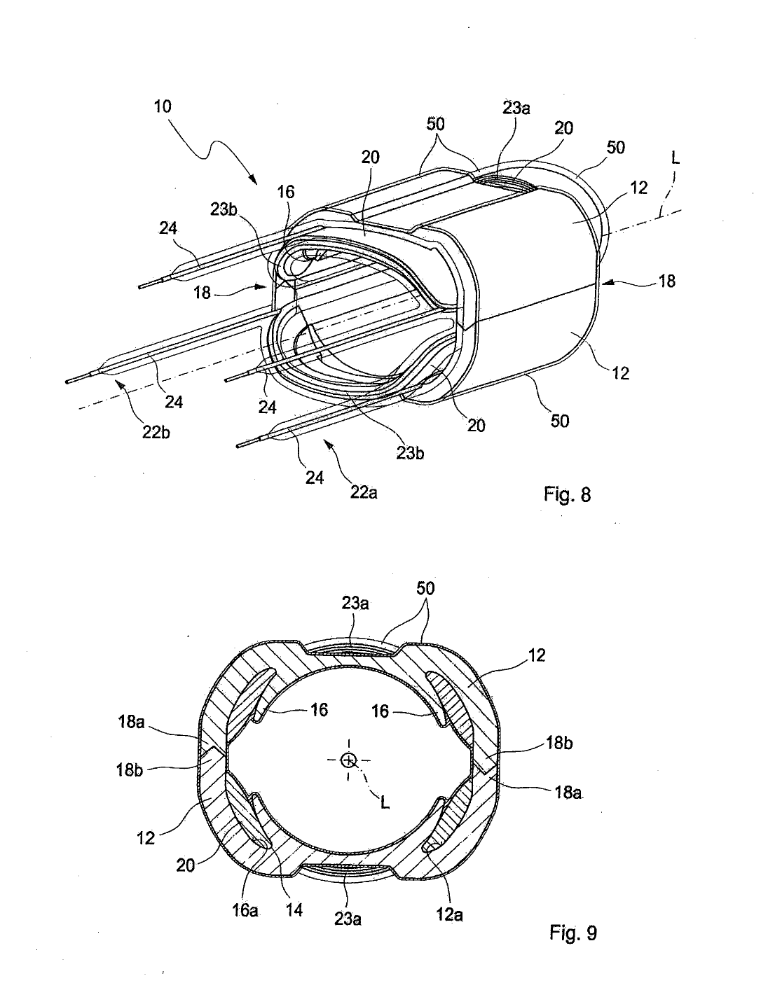

FIG. 8 shows an isometric view of the stator of the present invention and which is provided with a coating; and

FIG. 9 shows a transverse, vertical sectional view of the stator as illustrated in FIG. 8.

FIG. 1 shows a two-pole stator of an electric drive which is denoted overall by the reference symbol 10. This two-pole stator comprises a stator body, which is divided into two stator segments or stator halves 12 in the region of a partition plane extending along a longitudinal axis L of the stator. In this case, the two stator halves 12 are formed as identical parts, which makes the production of the stator body particularly simple. Generally, the illustrated stator body of the stator 10 is produced by stamping and stacking identical laminations to form a laminate stack.

Furthermore, each of the stator halves 12 comprises two pole horns or pole tips 16 (cf. also FIG. 2), which extend inwards from the inner circumferential face 12a of the respective stator half 12 and therefore delimit the interior of the stator 10 for a rotor to be accommodated therein (not illustrated).

The two stator halves 12 are connected to one another in the region of two connection points 18, with each stator half 12 having a first connection point 18a, and a second connection point 18b.

Furthermore, end sections or wire ends 22a and 22b of a coil wire 20, and which is inserted in the form of a coil, i.e. in the form of a coil 20a with a winding structure, and end windings 23a and 23b, are also shown in FIG. 1. As can be seen from FIG. 1, the wire ends 22a, 22b, as connecting wires, are each provided with heat-shrink tubing 24 as tube element, which heat shrink tubing does not end outside the stator 10, but is pushed into the stator 10, i.e. it protrudes into the winding structure of the coil 20a, in order to achieve optimum insulation and to further provide protection against conductive deposits. Suitable tube elements also include glass-fabric tubes.

In other exemplary embodiments, a sleeve element could also be provided instead of the tube element as illustrated.

As can clearly be seen from FIG. 2, the first connection point 18a of the two stator halves 12 is formed in each case by a triangular slot 18a running substantially parallel, and along the longitudinal axis L, while the second connection point 18b is formed by a corresponding triangular projection 18b running substantially parallel, and along the longitudinal axis L. Owing to the special formation of the first and second connection points 18a and 18b, simple production of the connection points 18 can be made possible.

Furthermore, and by virtue of the shape of the first and second connection points 18a and 18b, an alignment of the stator halves 12 with respect to one another is achieved if the respectively corresponding first connection point 18a and the second connection point 18b are brought to rest against one another. Finally, this special configuration of the connection points 18 helps in fabrication, in that the stator halves 12 can be readily stamped out of the material when resting directly against one another during the production of the stator body. This results in less waste being accumulated in comparison with the prior art fabrication processes.

FIG. 2 likewise clearly shows that the stator inner wall 12a and the radially outer wall 16a of the pole horns 16 delimits a slot 14, into which the coil wire 20, which is produced from copper can be accommodated. As can be seen from the figures (cf. in particular FIGS. 2 and 3), the coil wire 20, in the form of a coil 20a, is inserted into the coil space formed by the slots 14 in a stator half 12.

FIG. 2 also shows that the inserted coil wire 20 is not inserted into the slot 14 with a space factor of less than 100%, as is conventional in the prior art, but is wound out via the slot 14. This can be considered to be a particularly novel feature of the present invention since by virtue of achieving a space factor of more than 100%, an increased power of an electric motor with a stator 10 wound in this way can be achieved in relative comparison with an electric motor with a conventionally wound stator. In particular, the winding form shown in FIG. 2 makes it possible to arrange in total, more coil turns in a hollow-cylindrical volume element (which is located between the stator halves and the outer side of an armature) than is possible in accordance with the prior art. Given the same amount of physical space taken up, an increased magnetic flux can thus, overall, be produced with the coil 20a, and therefore, a higher power of the electric motor can be achieved. Likewise, for a given number of turns, the coil 20a can have a considerably flatter design than what was previously possible in accordance with the prior art teachings, with the result that, given the same turns number, an armature with a greater diameter can be used. This results in increased torque on the armature windings in comparison with the prior art, which likewise results in an increase in power. Furthermore, given the same power, a reduction in size of the electric motor, and therefore a reduction in the thread measure of an associated electric hand tool for example, can be achieved.

Since the mechanically stabilizing effect of the pole horns 16 is no longer present in the region emerging via the slot 14, additional measures are required for ensuring that the coil retains its shape and the windings do not detach from one another.

For this purpose, an at least partially cohesive connection of the turns of the coil 20a with respect to one another, and at least in parts of that region of the coil 20a, which is located outside the slot 14, is advantageous. This cohesive connection can be implemented, for example, by using a baked-enamel wire. A baked-enamel wire is understood within the teachings of this invention to mean a coil wire which has a thermally resistant base insulation, and a cover layer, which agglutinates on heating, and often also polymerizes in the process. In addition, or as an alternative, the cohesive connection can also be provided by means of an impregnating resin, which virtually completely penetrates the coil 20a after an immersion and owing to the capillary effect of the interspaces between the turns in the coil 20a.

As is shown in FIG. 3, the two-pole stator 10 with its two stator halves 12 comprises not only a stator body formed by the stator halves 12, and which stator body is wound with coil wire 20, but also insulating paper 30, which is inserted into the slots 14, before the coil wire 20 is wound onto the respective stator half 12.

The insulating paper 30 serves the purpose of protecting the coil 20a which is formed by the coil wire 20 from abrasion during operation of an electric motor having the stator 10, and further electrically insulating said coil from the stator body and the adjacent rotor (not illustrated). Thus, a minimum air gap of 2 mm between an active part, such as the stator body or the rotor, and the coil wire needs to be provided in order to ensure electrical insulation in accordance with the standard DIN EN 60745. This is ensured in the case of the abovementioned space factor, of the coil wire 20, of over 100% by virtue of the fact that the insulating paper 30 is provided with a radial overhang 32 (cf. also FIG. 4) beyond the respective pole horns 16.

A radial overhang 32 is understood to mean that part of the insulating paper 30 which overhangs radially, with respect to the longitudinal axis L, i.e. in a direction perpendicular to the longitudinal axis L, beyond the pole horns 16.

In this case, the overhang 32 of the insulating paper 30, as shown in FIG. 4, can be selected such that at least the radially inner sections of the overhanging insulating paper 32 rest against one another when the stator halves 12 are assembled, i.e. in the region of their connection points 18, and the overhangs 32 of the insulating paper 30 of the two stator halves 12, likewise rest against one another, or overlap one another. In addition, and as can be seen from FIG. 3, an axial (in relation to the longitudinal axis L of the stator 10) overhang 33 of the insulating paper 30 can also be expedient in order to ensure the electrical safety gap of an air gap of 2 mm exists between the coil wire, and the active iron. The above-mentioned axial overhang 33 is understood to mean that part of the insulating paper 30 which overhangs beyond the pole horns 16, and is oriented axially in relation to the longitudinal axis L, i.e. in a direction parallel to the longitudinal axis L.

As can be seen from FIG. 5a, a temperature sensor element 34 which is indicated by dashed lines, is provided in a cutout or a cavity 36 in the winding structure of the coil 20a in order to detect the temperature of the coil 20a, or the coil wire 20, during operation. The temperature sensor element 34 is at least approximately completely surrounded by the coil 20a, with the result that, in FIG. 5a, only the connecting lines 38 protrude out of the coil. The temperature sensor element 34 can be introduced only into one, or else into both, stator halves 12. As can be seen from FIG. 5b, the temperature sensor element 34 can, alternatively, also be accommodated in a cavity 36 in at least one of the coil slots 14. For this purpose, the temperature sensor element 34 can be arranged between the coil 20a on one side and the stator wall and/or one of the pole horns 16 on the other side.

A further special and novel feature of the present invention can be considered to be the fact that the two wire ends, or wire end sections 22a, 22b which are produced during the winding operation by the coil 20a at the stator halves 12, can be used as connecting wires or electrical connections of the electric motor, as mentioned above. For this purpose, the wire ends 22a, 22b are passed out of the coil 20a with a sufficiently long length in order to perform the function of separate litz wires known from the prior art, and to enable a connection of the coil 20a to a current source, or a distribution board (not shown). Separate connecting elements, for example, in the form of a crimping claw (not illustrated), can be fastened at the free ends of the wire end sections 22a, 22b in such a way that said connecting elements penetrate the insulating outer layer (in the example illustrated an insulating base layer, and a baked-enamel layer applied thereon) of the coil wire 20, and which enable an electrical contact to be made with the coil. The connecting elements (not illustrated) can also have an outer geometry shaped in the manner of a plug, and which can be plugged into a corresponding plug-type connector at the current source or the distribution board of the electric drive.

The production process of a two-pole stator will be described below with reference to the figures, as earlier described.

The two stator halves 12 which are intended to be wound with a source of copper wire in a further process step are first stamped, while resting against one another, out of a laminate stack produced by stamping and stacking of identical laminations.

In order to ensure sufficient electrical insulation during operation, and to be able to provide sufficiently large gaps between the coil, and other active parts of the electric motor, insulating paper 30 is inserted into the slots 14 in the respective stator halves 12 before the stator halves 12 are wound.

In order to ensure that the insulating paper 30 is fixed relative to the respective stator half 12, with the insulating paper 30 being inserted into the slot 14 in said stator half, the stator halves 12, in a previous process step, and prior to the insertion of the insulating paper 30 into the associated slots 14, can be heated at least in the region of the slots, for example, to a temperature of at least 150° Celsius. The insulating paper 30 is coated, at least sectionally, with a baked-enamel on that side with which it is intended to come to rest and against the heated slot 14 of the stator halves 12. The inserted insulating paper 30 can then be pressed against the slot, inner sides, for a few seconds, and as soon as said insulating paper is inserted into the associated slot 14. In the process, the baked-enamel coating fuses to the insulating paper 30 and thereby adhesively bonds the insulating paper to the stator half 12. It is therefore no longer necessary for the insulating paper 30 to be fixed during the subsequent process step of forming the winding.

The inserted insulating paper 30, as described, above, has a radial overhang 32 beyond the pole tips 16 of the respective stator halves 12. This overhang 32 can additionally be drawn radially inwardly during the subsequent winding operation in order to ensure, during the winding operation, that the insulating paper 30 is not bent by the coil wire 20.

In a further step, each of the stator halves 12 is wound with the coil wire 20, in an automated fashion, with the aid of a winding arm. In order to achieve the winding of the stator halves 12 in a manner in which the space factor of the coil slot 14 is above 100%, a former 40, as illustrated in FIG. 6, can be used. The former 40 as illustrated has an approximately semi-cylindrical central piece 48, with two former ends 46a and 46b, which are slightly set back or recessed from this central piece at the circumference, and which are further arranged at the opposite ends of the central piece. In this case, the central piece 48 is intended to be positioned onto a stator half 12 from the inner side, and wherein it is subsequently centered on this stator half in the axial direction by means of the former ends 46a and 46b. In this process, the central piece 48 has resting faces 481a and 481b, which overhang beyond the pole horns of the stator half when the former 40 is inserted, and thus provides an additional temporary slot, in which the coil wire 20 can be wound. The coil wire is guided and held there during and after the winding operation by means of the former 40 in this temporary slot.

In addition, the former 40 as illustrated in FIG. 6, also has one outer protrusion 44a, and 44b, respectively, and one inner protrusion 42a, and 42b on its former ends 46a and 46b, respectively. During the winding operation, the coil wire 20 can likewise be guided, and arranged, between the protrusions 42a and 44a or 42b and 44b, with the result that an end winding with a defined shape is produced so as to protrude beyond the stator half 12. In contrast to the prior art, therefore, the use of the former 40, firstly, makes it possible for even regions outside the slot 14 to be filled with coil wire 20, and secondly, also provides a defined shape for an end winding.

FIG. 7 shows the former 40 inserted in the stator half 12 after the winding operation. The figure clearly shows the defined formation of the end windings 23a, b, and which can be achieved by the protrusions 42a, 44a and 42b, 44b. Otherwise, the reference symbols used in FIG. 7 correspond to those already used in FIG. 6.

Before this former 40 is removed, and again in order to facilitate further manufacturing steps to the stator body, the coil 20a is at least partially baked or “initially baked”. For this reason, and in the present production process or methodology, a baked-enamel wire is used as coil wire 20, i.e. a copper wire with a thermally resistant base insulation and an additional baked-enamel cover layer, and which softens at temperatures of approximately 150° C. to 200° C., and then hardens, with the result that the individual coil turns, of the coil 20a, are held together in a combined structure, at least for the subsequent handling steps which take place during the manufacture, by the cured baked-enamel. In order to heat the baked-enamel in the manner as described, a current is introduced into the coil 20a, with the result that the coil is heated to the desired temperature (approximately 150° C. to 200° C.) as a result of its electrical resistance. For preliminary stabilization of the coil 20a, a current flow of approximately 50 A for a time period of approximately 4 seconds is sufficient. As a result the overall time for the manufacture can be kept relatively short. In the aforementioned method step, and in which the individual wire turns are baked to form a coil 20a, the overhang 32 of the insulating paper 30 can also be baked onto the coil 20a. In this regard, the insulating paper 30 can likewise have a baked-enamel coating at least in the region of its overhang 32, and on the side facing the coil 20a for this purpose.

Alternatively, however, it is likewise conceivable for the insulating paper to be baked directly onto the baked-enamel coating of the coil wire, or with the aid of a coating means to be applied separately on the coil. Furthermore, it is also conceivable for another coating means, or another cover layer to be used as a substitute for the baked-enamel and for fixing the coil turns to one another.

A spacer element (not illustrated), and in particular a pin, or the like, can be inserted into the region of the coil space in such a way that, when the coil wire 20 is inserted in an automated fashion into the coil space, the cavity 36, which is delimited by the spacer element in the winding structure of the coil 20a, or in at least one of the coil slots 14, results. Once the spacer element has been removed from the winding structure of the coil 20a, or from the at least one coil slot 14, the temperature sensor element 34 can be inserted into the remaining cavity 36.

The former 40 is designed, for example, in such a way that the corresponding cutout, or the cavity 36, remains in a region of the wound coil 20a, into which cavity, the temperature sensor element 34, can be inserted into the wound coil 20a in a further process oriented step. Alternatively, the spacer element which is separate from the former, can be used. The temperature sensor element 34 is fixed in the at least one cavity 36 of the coil 20a. This can take place by means of the fixing means of the coil wire 20. Alternatively, however, it is likewise conceivable for the temperature sensor element 34 to be baked directly to the baked-enamel coating of the coil wire 20, or to be fixed to the coil 20a with the aid of an additional sensor fixing means to be applied, separately. For this purpose, the temperature sensor element 34 can be coated, at least partially, with the sensor fixing means. The spacer element, and therefore also the cavity 36, can be provided in the region of the end winding 23a, and b, or in one of the coil slots 14, between the coil 20a, on one side, and the stator wall and/or one of the pole horns 16, on the other side. The additional sensor fixing means can comprise, for example, an adhesive, an impregnating resin or a baked-enamel.

Furthermore, an abovementioned spacer element can be inserted into the region of the coil space in such a way that, during automated insertion of the coil wire 20 into the coil space, a cavity, (not illustrated), and which is delimited by the spacer element, results in the region of the end sections 22a, and 22b in the winding structure of the coil 20a. Once the spacer element has been removed from the winding structure of the coil 20a, the heat shrink tubing 24 can be applied to the respective wire ends 22a, and 22b, and introduced into the remaining cavity in the winding structure of the coil 20a. Then the heat shrink tubing 24 is fixed into the winding structure of the coil 20a by means of a tube fixing means. The tube fixing means can comprise an adhesive or an impregnating resin, and/or preferably a dual-curing resin.

Finally, the connecting elements can be fastened at the free ends of the wire end sections 22a, and 22b, and wherein the connecting elements preferably not only act on the wire end sections 22a, and 22b but, in the fastened state, also pass through the heat shrink tubing 24 in order to be able to thus provide an optimum amount of insulation and protective effect for protecting the wire end sections 22a, and 22b, respectively.

Once the two stator halves 12 have been produced, and wound in this way, the stator halves are connected to one another in order to jointly form the stator body. For this purpose, the two stator halves 12 are rested against one another in the region of their connection points 18, with in each case one first connection point 18a of one stator half 12 being brought to rest against a second connection point 18b of the respective other stator half 12.

The two stator halves 12 resting against one another can be fixed to one another in a further step by means of an immersion impregnation. For this step, the two stator halves 12, which are resting against one another, or the wound-up coil 20a, can be heated and then immersed in an immersion bath, and in particular, within a dual-curing resin (impregnating resin or dual resin), and which further cures both under the effect of heat, and under the effect of UV light. Owing to the capillary effect of the interspaces which are formed between the individual turns of the coil 20a, the impregnating resin largely passes through this coil. As a result of the fact that the coil 20a is heated, the resin on the coil 20a and in particular also in the interior of the coil 20a, between the turns, can cure early, such as during the immersion process. As a result, the entire coil 20a can be mechanically stabilized to the extent that it withstands the mechanical loading during later use. In the outer regions of the stator 10, which do reach the same temperature as the coil 20a, the resin can be cured in a further step by means of exposure of it to UV light when using a dual resin.

The immersion impregnation as described, above, serves not only as additional protection for the entire stator body against abrasion, but also as a stator fixing means for the cohesive connection of the stator halves 12 with respect to one another. In principle, however, it is also conceivable for the two stator halves to be connected to one another cohesively, that is, for example, by means of adhesive bonding, welding, soldering, or the like, and prior to the immersion impregnation step. In this case, it is conceivable both, to only apply individual fixing points, and to provide a connection seam along the connection points 18, in order to hold the stator halves in their relative position with respect to one another during the immersion impregnation.

The stator fixing means, that being, the dual resin, can also act as tube fixing means, or as sensor fixing means.

The above-described immersion impregnation is extremely advantageous since it enables the coating of the coil, and the stator body, and the fixing of the stator halves to one another, in a single process step. Furthermore, owing to the immersion impregnation used, it is ensured that the stator forms an overall system which is both electrically optimally insulated per se, and is also protected against abrasion. The above-described partial baking, or initial baking, of the coil turns can be performed by the combination with the further process step of the immersion impregnation, and which is conducted within a time window of approximately 3 seconds since, as a result, the turns of the coil only need to be secured relative to one another to the degree that the former can be removed. The immersion impregnation which is performed in a further process step, ensures the sufficient stability of the coil during operation of the electric drive. If it were desirable for the coil to only be fixed by baking of the baked-enamel coating of the coil wire, increased baking times in the winding machine would be necessary. This would increase the overall time for manufacturing during fabrication/assembly in a disadvantageous manner.

FIGS. 8 and 9 show a stator 10, and which has been coated by means of immersion impregnation, as described, above. In principle, other coating methods for producing the coated stator 10, such as spraying, for example, are also conceivable. The reference symbols used in FIGS. 8 and 9 largely correspond to those used already in FIGS. 1 and 2.

FIG. 8 shows, in an isometric view, a stator 10, in which the end windings 23a and 23b have been provided with the common coating 50. It can clearly be seen from FIG. 8 that the common coating 50, in the exemplary embodiment as shown here, covers the stator body on its inner and outer side, and the end windings 23a and 23b, as well as the wire ends 22a, and 22b, respectively, and which are provided with the heat shrink tubing 24. Therefore, in the present, exemplary embodiment, a continuous coating 50 is formed over the entire stator 10, and this coating effectively protects all of the components owing to its design or characteristics as a common coating, the coating does not form any hard shoulders or transitions with which abrasively acting particles entrained in the cooling air flowing past same could attack.

FIG. 9 shows, in a vertical sectional view which is taken from a position that is perpendicular to the axis L, the profile of the coating 50. It can clearly be seen from FIG. 9 that the coating 50 is slightly thinner in the region of the stator body than in the region of the end windings 23a. The thicker coating in the region of the end windings 23a is in particular also advantageous because the end windings are generally subjected to the greatest extent to an abrasively acting flow of particles in the cooling air.

The stator 10 which is shown in FIGS. 8 and 9 can subsequently be inserted into a motor housing (not shown).

1. A Stator of an electric drive, comprising:
a stator body having two pole horns and further defining a coil space for accommodating a coil wire in the form of a coil having multiple turns, and wherein the coil space comprises a plurality of slots, which are delimited by a stator wall and the two pole horns of the stator, and wherein;
the coil wire which is inserted into the coil space is wound out via the slot which is located in the region between two pole horns.

2. A Stator to as claimed in claim 1, and wherein a cohesive connection between the turns of the coil is provided at least partially, at least in parts, of that region of the coil which is located outside the slot.

3. A Stator as claimed in claim 2, and wherein the coil wire is at least partially in the form of a baked-enamel wire.

4. A Stator as claimed in claim 3, and wherein about 40-60% of the coil wire is arranged outside of the slot.

5. A Stator as claimed in claim 4, and wherein the cohesive connection is formed, at least partially, by an impregnating resin.

6. A Method for producing a stator comprising:
providing a stator body with at least two stator segments, and two pole horns;
defining a coil space in the stator body for accommodating a coil wire in the form of a coil, and wherein the coil space has a slot;
inserting a former into one of the stator segments;
introducing the coil wire into the coil space, and wherein the coil wire is wound out via the slot and in the region which is located between the two pole horns;
cohesively connecting the turns of the coil at least partially, and at least in parts of that region of the coil which is located outside the slot; and
removing the former.

7. A Method as claimed in claim 6, and wherein the cohesive connection is performed using a baked-enamel wire as the coil wire.

8. A Method as claimed in claim 6, and wherein the cohesive connection is performed when the baked-enamel wire is subjected to an electrical current and is heated thereby.

9. A Method as claimed in claim 8, and wherein an electrical current with a current intensity in the range of about 30-70 A, and in particular about 50 A, is used for a time period of about 3-5 seconds, and in particular about 4 seconds.

10. A Method as claimed in claim 6, and wherein an impregnating resin is used for forming the cohesive connection of the turns.

11. A Method as claimed in claim 10, and wherein the stator body is immersed in the impregnating resin.

12. A method as claimed in claim 11, and wherein a first, provisional fixing of the turns by application of current is performed, and then, for a final fixing, an impregnating resin is used.
